(19) United States
(12) Patent Application Publication
(10) Pub. No.: US 2005/0136299 A1
(43) Pub. Date: Jun. 23, 2005

(54) Oxygen supply system

(76) Inventors: Joseph B. Richey II, Chagrin Falls, OH (US); Gerold Goertzen, Brunswick, OH (US); Cecelia Cropley, Acton, MA (US); Anthony J. Vaccaro, Southboro, MA (US); Subhash S. Aggarwal, North Vancouver (CA)

Correspondence Address: CALFEE HALTER & GRISWOLD, LLP, 800 SUPERIOR AVENUE, SUITE 1400, CLEVELAND, OH, 44114, US

(21) Appl. No.: 11/015,379

(22) Filed: Dec. 17, 2004

Related U.S. Application Data
(60) Provisional application No. 60/481,805, filed on Dec. 17, 2003.

(51) Int. Cl. H01M 8/06; H01M 8/18

(52) U.S. Cl. 429/17; 429/21; 204/DIG. 4

(57) ABSTRACT

A portable oxygen supply for home use may include an electrolyzer for generating oxygen from water in response to electric power input, and a fuel cell electrically connected with the electrolyzer for providing electric power to the electrolyzer. A method of providing oxygen for home use may include the steps of generating electricity in a fuel cell; providing electricity from the fuel cell to an oxygen source to operate the oxygen source to produce oxygen; and directing the oxygen from the oxygen source to a patient device.

### RELATED APPLICATION

This application claims the benefit of the filing date of U.S. Provisional Application No. 60/481,805, filed Dec. 17, 2003, the entire disclosure of which is hereby incorporated by reference.

### BACKGROUND OF THE INVENTION

The present invention relates to a breathing aid for a person. In particular, the invention relates to an oxygen supply system, which is preferably small and light enough to be portable, as would be desirable for use by a patient, for example, for home use.

### SUMMARY OF THE INVENTION

According to one embodiment, a portable oxygen supply for home use is provided. The supply includes, for example, an electrolyzer for generating oxygen from water in response to electric power input, and a fuel cell connected with the electrolyzer for providing electric power to the electrolyzer and water. According to another embodiment, a method of providing oxygen for home use is presented. The method includes, for example, the steps of: generating electricity in a fuel cell; providing electricity from the fuel cell to an oxygen source to operate the oxygen source to produce oxygen; and directing the oxygen from the oxygen source to a patient device.

### BRIEF DESCRIPTION OF THE DRAWINGS

FIG. 1 is a schematic illustration of an oxygen supply system in accordance with one embodiment of the invention;

FIG. 2 is a schematic illustration of an oxygen supply that forms part of the oxygen supply system of FIG. 1;

FIG. 3 is a schematic illustration of one embodiment of an oxygen generator that can be used in the oxygen supply system of FIG. 1;

FIG. 4 is a schematic illustration of a direct methanol fuel cell that can be used as the power source of FIG. 2;

FIG. 5 is a schematic illustration of the operation of a methanol fuel cell system that is one embodiment of the invention; and

FIG. 6 is a schematic illustration of a hydrogen fuel cell system that is another embodiment of the invention.

### DETAILED DESCRIPTION OF THE INVENTION

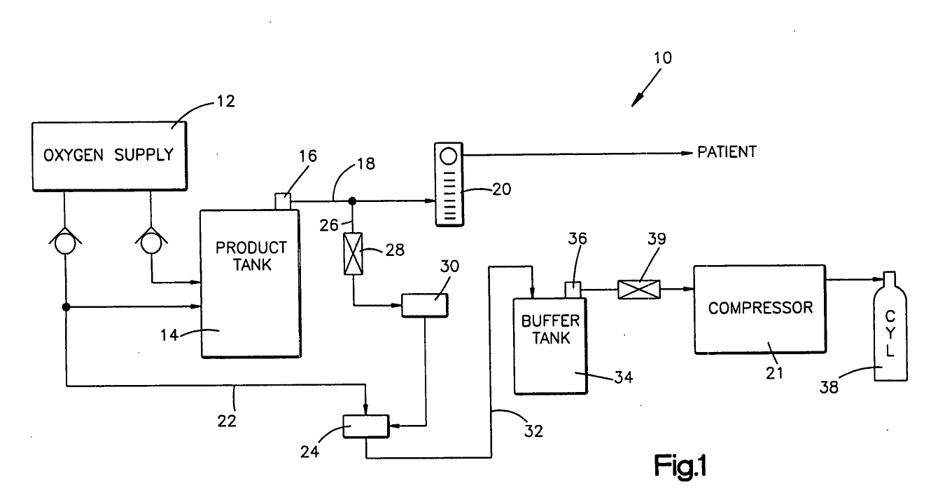

One embodiment of the present invention relates to a breathing aid for a person; for example, an oxygen supply system for home use that is preferably small and light enough to be portable. The invention is applicable to oxygen supply systems of various different types and constructions. As representative of one embodiment of the invention, FIG. 1 illustrates schematically an oxygen supply system 10. The system 10 includes an oxygen supply 12 that is also an embodiment of the invention. In one embodiment, the system 10 may be of the type shown in U.S. Pat. No. 5,988,165, the entire disclosure of which is hereby incorporated by reference.

The oxygen supply 12 is operable to provide oxygen-enriched gas for use in the system 10. The oxygen-enriched gas in the illustrated embodiment is fed to a product tank 14. In other embodiments, the product tank 14 can be omitted. A 5-psi regulator 16 emits oxygen-enriched gas from the product tank 14 into a flow line 18 and feeds the same to a flow meter 20 which subsequently emits the oxygen-enriched gas to the patient at a predetermined flow rate of from 0.1 to 6 liters per minute. Optionally, the flow meter 20 can be closed so that all the oxygen-enriched gas is directed to a compressor 21.

Gas not directed to the patient is carried via line 22 to two-way valve 24. A very small portion of the gas in the flow line 20 is directed through a line 26 and a restrictor 28 into an oxygen sensor 30 which detects whether or not the concentration of the oxygen is of a predetermined value, for example, at least 50 percent.

When the oxygen sensor 30 detects a concentration at or above the predetermined level, the two-way valve 24 is kept open to permit the oxygen-enriched gas to flow through the valve 24 and a line 32 into a buffer tank 34 wherein the pressure is essentially the same as the pressure in the product tank 14. However, should the oxygen sensor 30 not detect a suitable oxygen concentration, two-way valve 24 is closed so that the oxygen concentrator 12 can build up a sufficient oxygen concentration. This arrangement prioritizes the flow of oxygen-enriched gas so that the patient is assured of receiving a gas having a minimum oxygen concentration therein. In other embodiments, prioritization may be omitted.

The buffer tank 34 can have a regulator 36 thereon generally set at approximately 12 psi to admit the oxygen-enriched gas to the compressor 21 when needed. The output of the compressor 21 is used to fill a cylinder or portable tank 38 for ambulatory use by the patient. Alternatively, the pressure regulator 36 can be set at anywhere from about 13 to about 21 psi. A restrictor 39 controls the flow rate of gas from the buffer tank 34 to the compressor 21. Should the operation of the compressor 21 cause the pressure in the buffer tank 34 to drop below a predetermined value, a pressure sensor (not shown) automatically cuts off the flow of gas at a pressure above the pressure of the gas being fed to the patient. This prioritization assures that the patient receives priority with regard to oxygen-enriched gas.

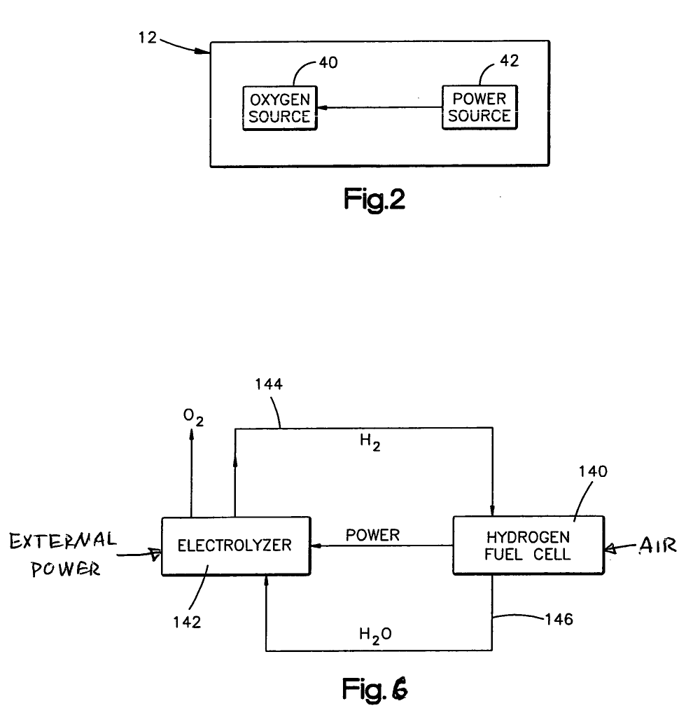

In accordance with one embodiment, the oxygen supply 12 is preferably configured and constructed so as to be small, light weight, and self-contained—that is, portable and/or transportable. The oxygen supply 12 is shown schematically in FIG. 2 as including an oxygen source 40 and a power source 42. Various different types of oxygen sources 40 may be used.

The oxygen source 40, shown schematically in FIG. 2, is preferably, although not necessarily, an electrolyzer, that is, a device that generates oxygen by splitting water through the application of electricity. At least two different types of electrolyzers are possible. One type of electrolyzer does not generate hydrogen, while the other type does produce hydrogen as a by-product. Other types of oxygen sources are described below.

In one embodiment, the oxygen source 40 includes a proton exchange medium between the electrodes. Feed water is electrolyzed at the anode to produce oxygen, hydrogen ions and electrons. The hydrogen ions are then combined with oxygen in the ambient air to produce water. The oxygen source 40 thus converts water and air into oxygen, air and water.

In another embodiment, the oxygen source 40 is of the known type of electrolyzer that produces hydrogen gas in addition to one or more other by-products.

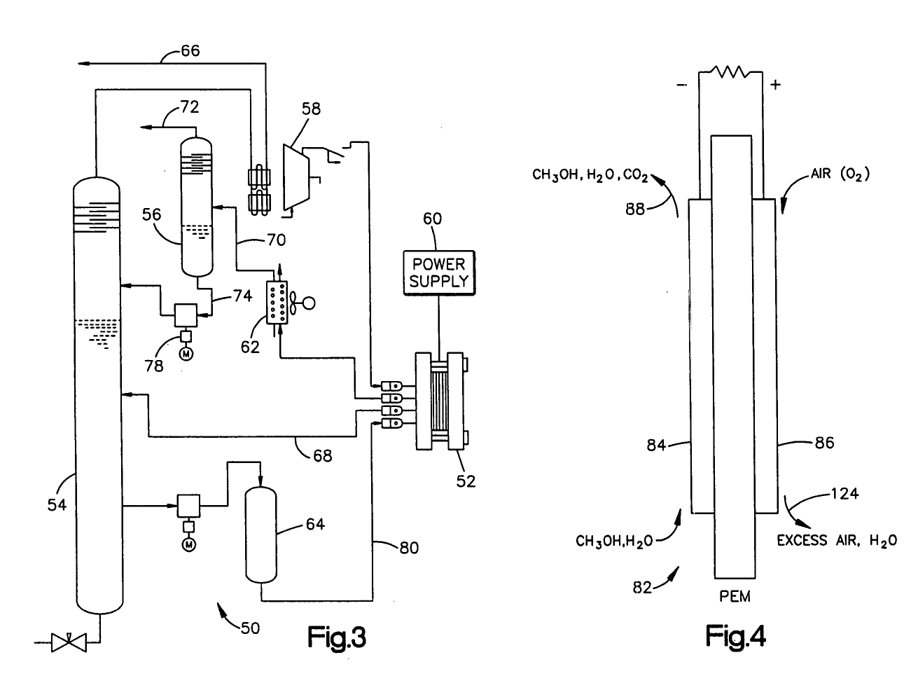

The oxygen from the oxygen source 40 can be collected, treated, pressurized, etc., in any one of numerous known manners. One example is shown in FIG. 3, which illustrates schematically one embodiment of operation of an oxygen concentrator 50 that uses an electrochemical stack or electrolysis cell 52, as one example of an oxygen source 40, to electrolyze water to produce oxygen, without producing hydrogen.

In this embodiment, concentrator 50 includes a water/oxygen separator 54, a water/air separator 56, an air source 58, and a power supply 60. Optionally, the oxygen concentrating system 50 may include one or more condensers 62 and one or more ion-exchange beds 64.

The oxygen from the stack 52 can be separated into a patient-grade oxygen-rich stream (oxygen, or oxygen-enriched gas) 66. This can be accomplished by delivering the oxygen product stream 68 from the electrolysis cell 52 to the oxygen-water separator 54. The water collects at the bottom of the oxygen-water separator reservoir 54, while the oxygen collects in the top portion of the reservoir until it can be bled off for patient use. One advantage of this arrangement is that the oxygen-rich stream 66 that is provided to the patient is saturated with water vapor. If the oxygen stream 100 is too dry, the nasal membrane of the patient might be irritated and possibly damaged. In other embodiments, humidification can be omitted.

The air product stream 70 from the electrolysis cell 52 can be separated in the water-air separator 56 to form a spent air stream 72 and a water stream 74. The spent air 72 can be vented to atmosphere, while the water stream 74 can be fed into the oxygen-water separator 20 and then recycled through the system as feed to the electrolysis cell.

A concentrator of this type, or of another type as used in the oxygen supply 12, may include a number of warning and detection systems. For example, an oxygen concentration sensor can be placed in the system to determine whether sufficient oxygen purity is being produced. A warning system, either visual or audio, can be used when the oxygen concentration falls below a predetermined value. The oxygen concentration sensor can also be used to trigger a system shut-down if the oxygen concentration falls below a predetermined value for a determined time period.

Impurities in the feed water to the electrolysis cell 40 or 52 may impair the functionality of the cell. Deionized or distilled water can be used in order to produce effective functionality of the electrolysis cell 50. Optionally, an ion exchange bed 64, or other filtration means, can be used in the system to filter out impurities in the feed water. The filtration mechanism can be used solely as a precautionary means, in that it will effectively remove trace amounts of impurities in the deionized feed water and allow for some use of non-deionized water in the system. Alternatively, the filtration mechanism can be larger, or replaceable, thereby allowing use of tap water on a regular basis.

Water level detection systems can also be used to ensure sufficient amounts of water are available to the system 50, most notably in the water/oxygen separator 54. For example, water can collect in the water/air separator 56 until a predetermined amount of water is collected. Once the predetermined amount of water is collected, a drain valve 78 can be opened to allow the water to be delivered to the water/oxygen separator 54, and subsequently as recycled water feed 80 to the electrolysis cell 52. A warning system can be used when the water level in the system falls below a predetermined critical operational level. The warning system can be one or two stages. In a one stage system, a warning signal will be triggered when the water level in the system falls below the predetermined level. This warning signal can be visual or audio. The two stage system can include a similar warning signal at a first predetermined level and then commence a system shut-down at a second predetermined level. In other embodiments, the system shut-down can occur after a predetermined time period following the actuation of the warning signal.

As noted above, different types of oxygen sources 40 can be provided. In place of the electrolysis cell and concentrator, the system could include a pressure swing concentrator, for example, that provides oxygen (or oxygen-enriched gas) from ambient air without electrolyzing water.

The oxygen supply 12 also includes a source of electric power 42 for the oxygen source 40. The power source 42 can be any conventional means of providing power, such as, for example, a battery, a generator, or an electrical connection to a power line in a house.

In one embodiment, power source 42 is a fuel cell that generates electricity used to power the oxygen source 40. Different types of fuel cells 42 can be used. One type of fuel cell 42 is a direct methanol fuel cell. Another type of fuel cell 42 is a hydrogen fuel cell.

FIG. 4 illustrates schematically the operation of one embodiment of a direct methanol fuel cell 82. The fuel cell 82 includes an anode 84 and a cathode 86. The fuel cell 82 is powered solely by methanol. A fuel cell 82 of this type can be sized to generate any level of desired power output, for example, 400 watts, enough to run an oxygen source 40 with the desired output.

A mixture of water and methanol is fed into the fuel cell 82 on the anode side 84. The molecules are electrolyzed to produce carbon dioxide and hydrogen ions. The hydrogen ions traverse the cell and are combined with air on the cathode side 86 to produce water. The carbon dioxide, and any non-electrolyzed water and methanol, are the products on the anode side 84 of the cell, and form a methanol/water product stream 88.

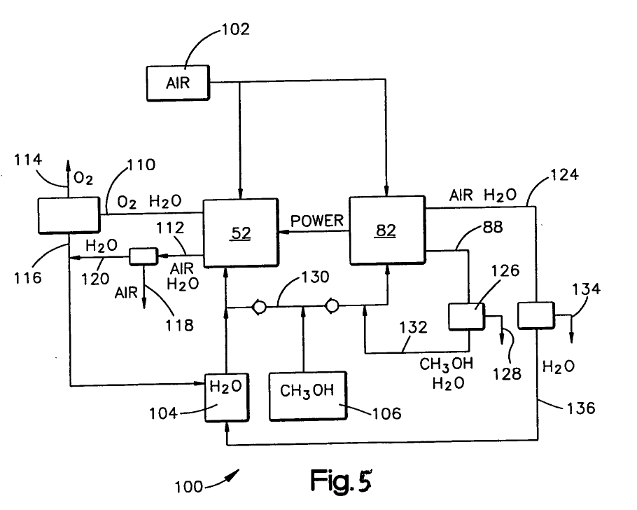

FIG. 5 illustrates one embodiment of a system 100 that combines a methanol fuel cell 82 and an electrolysis cell 52. An air supply 102 feeds air to both the fuel cell 82 and the electrolysis cell 52. Water from water supply 104 feeds the electrolysis cell 52 and combines with methanol from methanol supply 106 to feed the fuel cell 82. The fuel cell 82 supplies power to the electrolysis cell 52.

The products from the electrolysis cell 52 are an oxygen/water stream 110 and an air/water stream 112. The oxygen/water stream 110 is separated into an oxygen stream 114 and a water stream 116. The oxygen stream 114 can be fed to a patient or stored for subsequent use. Water stream 116 can be recycled to water supply 104.

The air/water stream 112 is separated into an air stream 118 and a water stream 120. The air stream 118 can be vented to atmosphere, while the water stream 120 can combine with water stream 116 for recycling to the water supply 104.

The fuel cell 82 produces a methanol/water/carbon dioxide stream 88 and an air/water/carbon dioxide stream 124. The methanol/water/carbon dioxide stream 88 can be fed into a separator 126, wherein any excess air or carbon dioxide is vented in stream 128, while the methanol and water are returned to the methanol/water feed stream 130 via stream 132. The air/water/carbon dioxide stream 124 is separated into air stream 134 and water stream 136. The air stream 134 can be vented to atmosphere, while the water stream 136 is recycled to the water supply 104.

The combination of the methanol fuel cell 82 and the oxygen concentrator electrolysis cell 52 can provide for an efficient and portable system that can generate patient-grade oxygen for prolonged periods of time. The patient grade oxygen supply can be used in the home or it can be used for individual use when in transit. The air water separator for the fuel cell and the oxygen concentrator can be combined, thereby making the system more compact. In addition, only one water level need be maintained. The water product of the fuel cell can also be used as a portion of the feed to the oxygen concentrating electrolysis cell, thereby requiring less water to be added to the system on a regular basis.

One embodiment of a hydrogen fuel cell is shown schematically at 140 in FIG. 6. A hydrogen fuel cell 140 uses hydrogen as an input fuel and also has an air input. If the oxygen source 142 is an electrolyzer as in the embodiment of FIG. 7, it produces hydrogen 144 as a by-product. This excess hydrogen 144 can be recycled into the hydrogen fuel cell 140. This avoids venting hydrogen to the atmosphere. The electrolyzer 142 may require external power, as shown in FIG. 7, in addition to the power provided by the fuel cell.

In addition, for any type of fuel cell that produces water 146 as a by-product, this water can be recycled into the electrolyzer to meet its demand for water.

While the present invention is disclosed through various embodiments, descriptions, and illustrations, further embodiments and modifications based on this disclosure are also possible. For example, fuel cell technology based on other sources and types of input fuels can also be used. Electrolyzers of different physical construction and material composition can also be employed. Therefore, the invention in its broader aspects is not limited to the specific embodiments, illustrations, and descriptions presented herein.

1. A method comprising the steps of:
generating electricity in a fuel cell;
providing electricity from the fuel cell to an oxygen source to operate the oxygen source to produce oxygen; and
directing the oxygen from the oxygen source to a patient device.

2. A method as set forth in claim 1 wherein the directing step comprises directing the oxygen to a nasal mask.

3. A method as set forth in claim 1 wherein the directing step comprises directing the oxygen to a portable tank for supplying oxygen to a patient.

4. A method as set forth in claim 1 wherein the step of providing electricity comprises providing electricity from a direct methanol fuel cell.

5. A method as set forth in claim 1 wherein the step of providing electricity comprises providing electricity from a hydrogen fuel cell.

6. A method as set forth in claim 5 further including the steps of directing hydrogen from the oxygen source to the hydrogen fuel cell and directing water from the hydrogen fuel cell to the oxygen source.

7. An oxygen supply comprising:
an electrolyzer for generating oxygen from water in response to electric power input, and
a fuel cell electrically connected with the electrolyzer for providing electric power to the electrolyzer.

8. An oxygen supply as set forth in claim 7 wherein:
the electrolyzer has a water input and a hydrogen byproduct;
the fuel cell has a hydrogen input and a water byproduct;
the supply including a first flow line for directing the hydrogen byproduct of the electrolyzer into the hydrogen fuel cell; and
the supply including a second flow line for directing the water byproduct of the fuel cell into the electrolyzer.

9. An oxygen supply as set forth in claim 7 wherein the fuel cell is a direct methanol fuel cell.

10. A process for filling a portable container with oxygen-enriched gas under high pressure, comprising the steps of;
providing electric power to an oxygen source from a fuel cell;
operating the oxygen source to provide oxygen-enriched gas;
transferring the oxygen-enriched gas to a compressor at an initial pressure level;
compressing the oxygen-enriched gas admitted to the compressor to a high-pressure; and
transferring the high-pressure, oxygen enriched gas to a portable container for subsequent use by a patient.

11. An apparatus for collecting and storing or distributing an oxygen-enriched gas, comprising;
a first storage vessel having an inlet and an outlet;
an oxygen source which provides oxygen-enriched gas at a relatively low pressure to the first storage vessel inlet;
a fuel cell for providing electric power to the oxygen source;
a pressure control device which receives a first component of the low pressure oxygen-enriched gas and outputs the oxygen-enriched gas at a reduced set pressure for use by a patient;
a buffer tank having an outlet and an inlet adapted to receive a second component of the oxygen-enriched gas at the low pressure from the first storage tank outlet;
a second storage vessel;
a compressor connected to the buffer tank outlet which compresses the oxygen-enriched gas and outputs oxygen-enriched gas at a relatively high pressure to the inlet of the second storage vessel; and
prioritizing apparatus connected between the outlet of the first storage vessel and the compressor and which interrupts the flow of the second component of oxygen-enriched gas to the compressor when the pressure of the second component of oxygen-enriched gas falls below a preset amount to ensure that the first component is sufficient to ensure the output of the pressure control device is at the reduced set pressure.
